(19) United States
(12) Patent Application Publication
(10) Pub. No.: US 2023/0176273 A1
(43) Pub. Date: Jun. 8, 2023

(54) DISPLAY DEVICE WITH RUNNING OUT-COUPLING GRATING

(71) Applicant: Meta Platforms Technologies, LLC, Menlo Park, CA (US)

(72) Inventors: Jacques Gollier, Sammamish, WA (US); Renate Eva Klementine Landig, Kirkland, WA (US)

(21) Appl. No.: 17/963,994

(22) Filed: Oct. 11, 2022

Related U.S. Application Data
(60) Provisional application No. 63/286,349, filed on Dec. 6, 2021.
(60) Provisional application No. 63/286,230, filed on Dec. 6, 2021.
(60) Provisional application No. 63/341,416, filed on May 12, 2022.
(60) Provisional application No. 63/392,403, filed on Jul. 26, 2022.

(51) Int. Cl. F21V 8/00; G02B 27/01; G02F 1/01; G06F 3/01; G06F 1/16

(52) U.S. Cl. CPC G02B 6/0033; G02B 27/0172; G02B 27/0179; G02F 1/0136; G02B 6/0056; G06F 3/013; G06F 1/163; G02B 2027/0178; G02B 2027/0187; G02B 2027/0174; G02F 1/137

(57) ABSTRACT

A display device includes an image projector and a pupil-replicating lightguide having an out-coupling grating with configurable dynamic spatial distribution of out-coupling efficiency that may be adjusted depending upon several factors including currently displayed portion of the field of view as well as the eye position and orientation at the eyebox of the display device. For scanning display systems, the out-coupling grating may be configured to have a high-efficiency grating area that “runs” along the grating in coordination with the scanning to provide a more efficient light utilization in the display device.

### REFERENCE TO RELATED APPLICATION

This application claims priority from U.S. Provisional Patent Application No. 63/286,349 entitled “Active Gratings in Pupil-Replicated Displays and Illuminators”, U.S. Provisional Patent Application No. 63/286,230 entitled “Active Fluidic Optical Element”, both filed on Dec. 6, 2021 and incorporated herein by reference in their entireties; from U.S. Provisional Patent Application No. 63/341,416 entitled “Active Eyebox Solutions and Applications” filed on May 12, 2022, and from U.S. Provisional Patent Application No. 63/392,403 filed Jul. 26, 2022 entitled “DISPLAY DEVICE WITH RUNNING OUT-COUPLING GRATING, which are incorporated herein by reference in their entireties.

### TECHNICAL FIELD

The present disclosure relates to visual displays, and in particular to visual display devices using pupil-replicating lightguides.

### BACKGROUND

Visual displays provide information to viewer(s) including still images, video, data, etc. Visual displays have applications in diverse fields including entertainment, education, engineering, science, professional training, advertising, to name just a few examples. Some visual displays, such as TV sets, display images to several users, and some visual display systems, such s near-eye displays or NEDs, are intended for individual users.

An artificial reality system generally includes an NED, for example a headset or a pair of glasses, configured to present content to a user. The NED may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by seeing through a “combiner” component. The combiner of a wearable display is typically transparent to external light but includes some light routing optics to direct the display light into the user's field of view.

Because a display of HMD or NED is usually worn on the head of a user, a large, bulky, unbalanced, and/or heavy display device with a heavy battery would be cumbersome and uncomfortable for the user to wear. Head-mounted display devices require compact and efficient optical train that conveys an image generated by a microdisplay or a beam scanner to eyes of a user.

### BRIEF DESCRIPTION OF THE DRAWINGS

Exemplary embodiments will now be described in conjunction with the drawings, in which:

FIG. 1 is a schematic side view of a display device of this disclosure with an out-coupling grating having a spatially selective tunable out-coupling efficiency;

FIG. 2A is a plan view of a scanned field of view (FOV) with a high-efficiency portion of the out-coupling grating of FIG. 1 running in coordination with scanning lines;

FIG. 2B is a plan view of the scanned FOV with the high-efficiency portion of the out-coupling grating of FIG. 1 running in coordination with scanned pixels or pixel areas;

FIG. 3 is a schematic side view of a display device of this disclosure illustrating how a position of the high-efficiency portion of the out-coupling grating depends on the scanning angle and the user's eye position;

FIG. 4A is a side schematic view illustrating the dependence of the high-efficiency portion position on the eye position;

FIG. 4B is a side schematic view illustrating the dependence of the high-efficiency portion position on the eye gazing angle;

FIG. 5 is a flow chart of a method for providing a line of an image in angular domain in accordance with this disclosure;

FIG. 6 shows side cross-sectional views of a tunable liquid crystal (LC) surface-relief grating usable in a lightguide of this disclosure;

FIG. 7A is a frontal view of an active Pancharatnam-Berry phase (PBP) liquid crystal (LC) grating usable in a lightguide of this disclosure;

FIG. 7B is a magnified schematic view of LC molecules in an LC layer of the active PBP LC grating of FIG. 7A;

FIGS. 8A and 8B are side schematic views of the active PBP LC grating of FIGS. 7A and 7B, showing light propagation in OFF (FIG. 8A) and ON (FIG. 8B) states of the active PBP LC grating;

FIG. 9A is a side cross-sectional view of a polarization volumetric grating (PVH) usable in a lightguide of this disclosure;

FIG. 9B is a diagram illustrating optical performance of the PVH of FIG. 9A;

FIG. 10A is a side cross-sectional view of a fluidic grating usable in a lightguide of this disclosure, in an OFF state;

FIG. 10B is a side cross-sectional view of the fluidic grating of FIG. 12A in an ON state;

FIG. 11 is a view of an augmented reality (AR) display of this disclosure having a form factor of a pair of eyeglasses; and

FIG. 12 is a three-dimensional view of a head-mounted display (HMD) of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

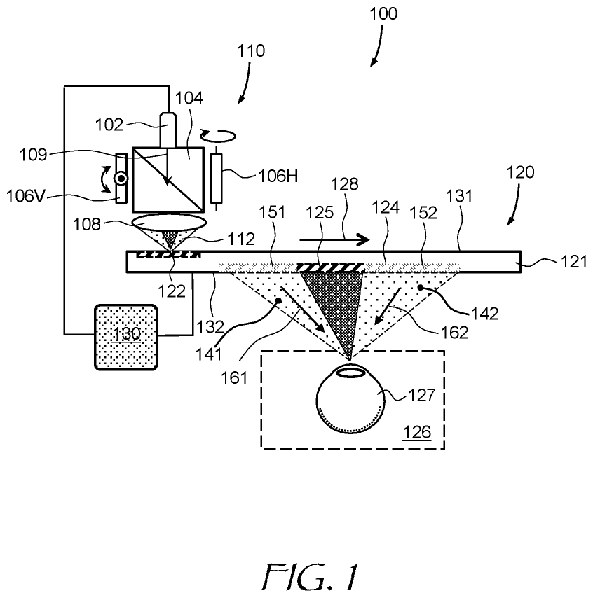

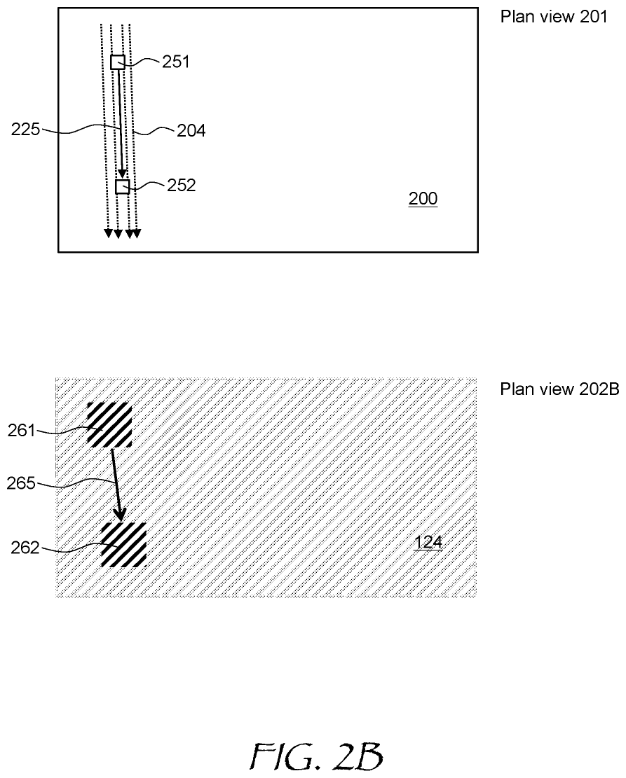

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 1 and 3, similar reference numerals denote similar elements.

Near-eye displays and augmented reality displays may use pupil-replicating lightguides to expand image light carrying a projected image over an eyebox of the display, i.e., over an area where a user's eye may be located during normal operation of the display. A pupil-replicating lightguide may include a plano-parallel slab of a transparent material propagating the image light in a zigzag pattern by total internal reflection (TIR) from the waveguide's top and bottom surfaces.

One drawback of pupil-replicating lightguides is that by spreading the image light over an extended area, a considerable portion of the image light coupled into the pupil-replicating lightguide never reaches the eye pupil, illuminating instead the user's eyes and face. This causes a considerable reduction of the overall light utilization efficiency. A poor light utilization efficiency may be compensated by using a brighter light source; however, this requires a larger and heavier battery, which increases the size and weight of the display making it uncomfortable to wear for extended periods of time. Furthermore, when the lightguide is a part of an augmented reality system, the image light from an image source internal to the augmented reality system has to compete in brightness with outside light visible by the display user. The augmented image brightness may need to be increased by several orders of magnitude for the generated imagery to be visible in broad daylight. It is therefore highly desirable to improve the light utilization efficiency by a pupil-replicating lightguide.

In accordance with this disclosure, a pupil-replicating lightguide of a display device may include an out-coupling grating having an out-coupling efficiency tunable in a spatially-selective, time-variant manner, enabling the distribution of the image light portions at the eyebox to match the eye pupil position and eye orientation. Thus, the image light distribution may be optimized to account for the eye position and orientation, as well as for a currently displayed portion of the field of view (FOV). The goal is to not send the light energy to eyebox locations where the eye pupil is not present, and/or to not send the image light energy into FOV portions currently not displayed or otherwise non-visible by the viewer.

In accordance with the present disclosure, there is provided a display device comprising an image projector for providing image light carrying an image in angular domain, and a pupil-replicating lightguide coupled to the image projector and comprising an out-coupling grating for out-coupling spaced apart portions of the image light towards an eyebox. An out-coupling efficiency of the out-coupling grating is tunable in a spatially-selective manner for providing a configurable distribution of the image light portions at the eyebox.

The display device may include a controller operably coupled to the image projector and the out-coupling grating and configured to: cause the image projector to provide a first field of view (FOV) portion; increase the out-coupling efficiency of a first portion of the out-coupling grating to increase a first portion of the image light corresponding to the first FOV portion; cause the image projector to provide a second, different FOV portion; and increase the out-coupling efficiency of a second portion of the out-coupling grating to increase a second portion of the image light corresponding to the second FOV portion. The first FOV portion may include a first line of the image in angular domain, and the second FOV portion may include a second, different (not necessarily subsequent) line of the image in angular domain. The first FOV portion may include a first section of the image in angular domain, and the second FOV portion may include a second, different (not necessarily subsequent) section of the image in angular domain. Each section may include several lines.

The display device may further include an eye tracking system for determining a position of a pupil of a user's eye at the eyebox. In such embodiments, the controller may be operably coupled to the image projector, the out-coupling grating, and the eye tracking system, and configured to: cause the eye tracking system to determine the position of the pupil of the user's eye; cause the image projector to provide a first field of view (FOV) portion; and increase the out-coupling efficiency of a first portion of the out-coupling grating to increase a first portion of the image light at the position of the pupil determined by the eye tracking system, the first image light portion corresponding to the first FOV portion.

In some embodiments, the out-coupling grating may include at least one of a polarization volume hologram (PVH) grating, a tunable Pancharatnam-Berry phase (PBP) liquid crystal (LC) grating, a fluidic surface-relief grating, etc. The image projector may include a scanning image projector, for example.

In accordance with the present disclosure, there is provided a display device comprising a scanning image projector for scanning a light beam to provide a line of an image in angular domain, and a pupil-replicating lightguide coupled to the image projector and comprising an out-coupling grating for out-coupling spaced apart portions of the light beam towards an eyebox. An out-coupling efficiency of the out-coupling grating is tunable in a spatially-selective manner. The display device may further include a controller operably coupled to the scanning image projector and the out-coupling grating and configured to: cause the scanning image projector to scan the light beam from a first pixel to a second pixel of the line of the image; and tune the out-coupling efficiency of the out-coupling grating to provide a high-efficiency portion of the out-coupling grating running in coordination with scanning of the light beam by the scanning image projector, to keep a first portion of the light beam at a first location at the eyebox during the scanning, wherein the first portion is out-coupled by the high-efficiency portion of the out-coupling grating. In some embodiments, an x-coordinate x(t) of the high-efficiency portion is expressed as x(t)=D*tan(θ(t)), wherein D is a distance between the out-coupling grating and the first location, θ(t) is an instantaneous scanning angle of the light beam, and t is time.

In some embodiments, the display device further includes an eye tracking system operably coupled to the controller for determining a position of a pupil of a user's eye at the eyebox, wherein the first location is at the pupil position determined by the eye tracking system. The controller may be further configured to adjust the first location upon determining, using the eye tracking system, that the pupil position has shifted. The controller may be further configured to adjust the first location upon determining, using the eye tracking system, that a gaze direction of the user's eye has shifted.

In accordance with the present disclosure, there is further provided a method for providing a line of an image in angular domain to a first location at an eyebox. The method includes angularly scanning a light beam while modulating its brightness to provide the line of the image in angular domain; providing the scanned light beam to a pupil-replicating lightguide comprising an out-coupling grating having an out-coupling efficiency tunable in a spatially-selective manner; and tuning the out-coupling efficiency of the out-coupling grating to provide a high-efficiency portion of the out-coupling grating running in coordination with the scanning of the light beam, to keep a first portion of the light beam at a first location at the eyebox during the scanning, wherein the first portion is out-coupled by the high-efficiency portion of the out-coupling grating. In some embodiments, an x-coordinate x(t) of the high-efficiency portion is expressed as x(t)=D*tan(θ(t)), wherein D is a distance between the out-coupling grating and the first location, θ(t) is an instantaneous scanning angle of the light beam, and t is time.

In some embodiments, the method further includes using an eye tracking system to determine a position of a pupil of a user's eye at the eyebox, wherein the first location is at the pupil position determined by the eye tracking system. The first location may be adjusted upon determining, using the eye tracking system, that the pupil position has shifted.

Referring now to FIG. 1, a display device 100 includes an image projector 110 for providing image light 112 carrying an image in angular domain to be displayed to the viewer. Herein, the term “image in angular domain” means an image where each pixel is represented by a ray angle of image light, the color and/or brightness of a light beam at the ray angle representing the color and/or brightness of the corresponding pixel of the image being displayed. Such an image may be viewed by an eye directly, without an ocular lens or another angle-to-offset optical element in front of the eye. In the embodiment shown, the image projector 110 includes a light source 102 for providing a collimated light beam 109 with variable brightness and, optionally, color, a polarization beam splitter (PBS) 104 for folding the optical path by polarization, a pair of tiltable reflectors 106H and 106V for horizontal and vertical scanning of the light beam respectively, and an optional pupil relay 108.

A pupil-replicating lightguide 120 is coupled to the image projector 110. The pupil-replicating lightguide 120 may be implemented in a slab of transparent material 121 for conveying the image light 112 by a series of alternating zigzag reflections from top 131 and bottom 132 surfaces of the slab 121, e.g. total internal reflections (TIRs). An in-coupler 122, e.g. an in-coupling grating, may be provided for in-coupling the image light 112 into the slab 121.

The pupil-replicating lightguide 120 further includes an out-coupling grating 124 for out-coupling spaced apart portions of the image light towards an eyebox 126. An out-coupling efficiency of the out-coupling grating 124 is tunable in a spatially-selective manner for providing a configurable distribution of the image light portions at the eyebox 126. Herein and throughout the rest of the specification, the terms “switchable”, “tunable”, and “variable” may be used interchangeably. These terms mean that the grating strength, blazing angle, etc., may be controlled by applying an external control signal. In the illustrated example, the grating efficiency spatial distribution includes a high-efficiency region 125 which moves or “runs” from left to right, as indicated by an arrow 128.

The display device 100 may further include a controller 130 operably coupled to the image projector 110 and the pupil-replicating lightguide 120, specifically to its out-coupling grating 124 of the pupil-replicating lightguide 120. The controller 130 may be configured to tune the spatial distribution of the out-coupling efficiency of the out-coupling grating 124 in coordination with operating the image projector 110, to optimize the out-coupling of the image light portions carrying currently displayed FOV portion to a user's eye 127. For example, the controller 130 may cause the image projector 110 to provide a first FOV portion 141, and increase the out-coupling efficiency of a first portion 151 of the out-coupling grating 124 to increase a first portion 161 of the image light 112, the first image light portion 161 corresponding to the first FOV portion 141. The controller may cause the high-efficiency region 125 to shift or run along the out-coupling grating 124 in sync or in coordination with the FOV scanning by the image projector 110. By the time the image projector 110 provides a second, different FOV portion 142, the controller 130 increases the out-coupling efficiency of a second portion 152 of the out-coupling grating 124 to increase a second portion 162 of the image light 112 corresponding to the second FOV portion 142. This enables the out-coupling grating 124 to always be optimized for out-coupling the FOV portion that is currently being provided by the image projector 110, thereby improving the overall light utilization efficiency.

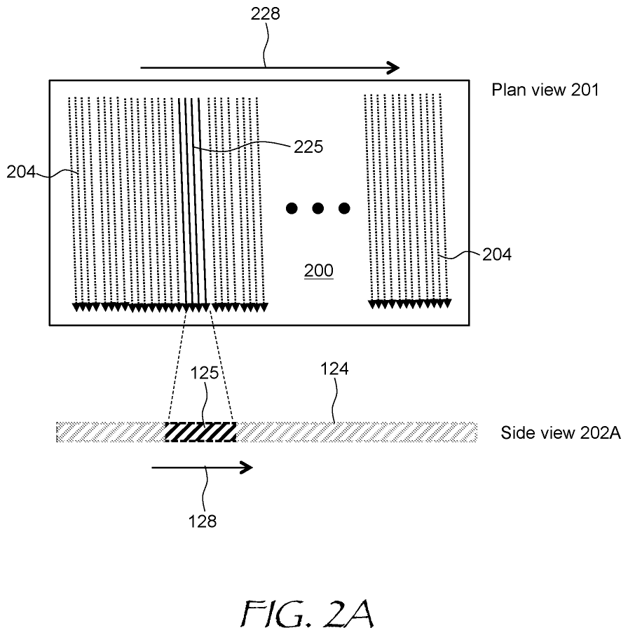

FIG. 2A illustrates one embodiment of the scanning optimization concept of FIG. 1. A top portion of FIG. 2A is a plan view 201 of an FOV 200 being provided by the image projector 110. In this embodiment, the image projector 110 scans the entire FOV line-by-line, as represented by arrows 204, eventually covering the entire FOV 200. Such a scanning may be provided, for example, by scanning the vertical tiltable reflector 106V quickly while scanning the horizontal tiltable reflector 106H slowly; the arrows 204 appear tilted due to the simultaneous continuous scanning. The high-efficiency region 125 corresponds to one or several lines 225 of the FOV being currently scanned. The currently scanned lines are shown with solid arrows, whereas the scanned lines or the lines to be scanned are shown with dashed arrows.

A bottom portion of FIG. 2A is a side view 202A of the out-coupling grating 124. As the scanned lines 225 shift from left to right as indicated with an arrow 228 in the top view 201, the high-efficiency region 125 of the out-coupling grating 124 shifts left to right to provide high out-coupling efficiency for the image light portions carrying or representing the currently provided FOV portions, i.e. the currently scanned line(s) 225. The shift of the high-efficiency region 125 is indicated with the arrow 128. In relation to the scanning described above with reference to FIG. 1, the first FOV portion 141 of FIG. 1 includes one or several lines 225 (FIG. 2A) of the image in angular domain, and the second FOV portion 142 includes a second, different line or set of lines of the image in angular domain. Several consecutive lines may form a section that is being tracked by the high-efficiency region 125. Herein, the terms “first line” and “second line” or “first section” and “second section” do not necessarily imply that the two lines or sections are conterminous, or are consecutively scanned. In other words, the two lines may be non-conterminous and/or may belong to different sections of lines, and two different sections may be non-conterminous/non-consecutive.

The scanning may be optimized not only for section-by-section and line-by-line scanning, but also for pixel-by-pixel scanning at a high enough speed of tunability of the out-coupling grating 124. FIG. 2B illustrates a pixel-by-pixel scanning embodiment of a display device with optimized out-coupling of image light. In this embodiment, the image projector 110 scans the entire FOV pixel-by-pixel, as represented by first 251 and second 252 pixels, eventually covering the entire FOV 200. There may be other pixels between the first 251 and second 252 pixels. The first 251 and second 252 pixels may belong to a same straight line of scanning, or to a more complex nonlinear scanning trajectory of a nonlinear resonant scanner including one or more mirrors oscillated at a resonant frequency.

A bottom portion of FIG. 2B is a plan view 202B of the out-coupling grating 124. As the scanning progresses from the first pixel 251 to the second pixel 252, the high-efficiency region of the out-coupling grating 124 shifts from a first location 261 to a second location 262 as indicated with a solid arrow 265. In relation to the scanning described above with reference to FIG. 1, the first FOV portion 141 of FIG. 1 includes the first pixel 261 (FIG. 2B) of the image in angular domain, and the second FOV portion 142 includes the second pixel 262 of the image in angular domain. In some embodiments, the image projector 110 may be replaced with a non-scanning projector, e.g. an image projector based on a microdisplay and an objective (collimator) lens or another offset-to-angle optical element.

Turning to FIG. 3, a display device 300 is similar to the display device 100 of FIG. 1, and includes similar elements. The display device 300 of FIG. 3 includes the image projector 110 for providing the image light 112 carrying an image in angular domain to be displayed to the user's eye 127. The display device 300 further includes the pupil-replicating lightguide 120 coupled to the image projector 110. The pupil-replicating lightguide 120 include the slab 121 of transparent material. The in-coupler 122 in-couples the image light 112 into the slab 121, which conveys the image light 112 by a series of alternating reflections, e.g. TIRs, forming a zigzag optical path, not shown. The pupil-replicating lightguide 120 further includes the out-coupling grating 124 for out-coupling portions of the image light towards the user's eye 127. The portions are spaced apart along the zigzag optical path. The out-coupling efficiency of the out-coupling grating 124 is tunable in a spatially-selective manner for providing a configurable distribution of the image light portions at the eyebox 126.

The display device 300 may further include a controller 330 operably coupled to the image projector 110 and the out-coupling grating 124 of the pupil-replicating lightguide 120. The controller 330 may be configured to tune the spatial distribution of the out-coupling efficiency of the out-coupling grating 124 in coordination with operating the image projector 110, to increase the out-coupling of the spaced apart image light portions carrying the currently displayed FOV portion to the eyebox 126, in the following manner. The scanning image projector 110 scans the collimated light beam 109 generated by the light source 102. The controller 330 tunes the out-coupling efficiency of the out-coupling grating 124 to run a high-efficiency portion 351 of the out-coupling grating 124 along the slab 121 and in coordination with the scanning of the collimated light beam 109 by the scanning image projector 110. The controller 330 is configured to keep a first portion 361 of the light beam at a location 381 of the eye 127 in the eyebox 126 during the scanning. As illustrated in FIG. 3, the first portion 361 is out-coupled by the high-efficiency portion 351 of the out-coupling grating 124. The controller 330 may further adjust the out-coupling efficiency distribution, e.g. the location of low- and high-efficiency portions or areas of the out-coupling grating 124, based on data obtained from an optional eye tracking system 340 coupled to the controller 330, as will be explained further below.

The controller 330 may scan the collimated light beam 109 in accordance with a pre-defined scanning trajectory. By way of a non-limiting example, considering a on-dimensional scanning for simplicity, the scanning angle θ of the collimated light beam 109 may be described by a scanning function 8(t), i.e. 8(t) is an instantaneous scanning angle of the collimated light beam 109 at the time moment t. It follows from the geometry of FIG. 3 that an x-coordinate x(t) of the high-efficiency portion 351 may be expressed as

x(t)=D*tan(θ(t)), (1)

where D is a distance between the out-coupling grating 124 and the eye location 381. As the angle θ of the collimated light beam 109 is scanned, the high-efficiency portion 351 of the out-coupling grating 124 “travels” to a second location 351′, while the corresponding out-coupled image light portion 361′ remains directed at the eye location 381. The eye location 381 at any given moment of time may be determined by using the eye tracking system 340. When the eye location 381 changes, the controller 330 may adjust the high-efficiency portion 351 movement function x(t) accordingly, to keep the out-coupled image light at the updated eye location at all times.

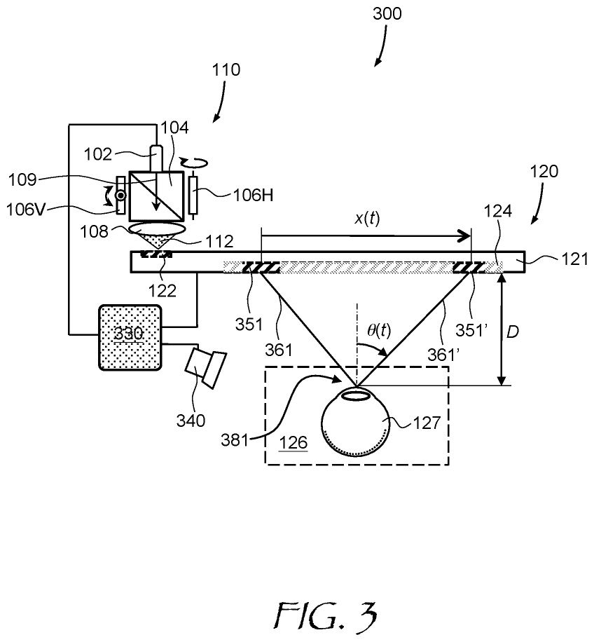

The adjustment of the movement function x(t) depending on the eye location is illustrated in FIG. 4A. At a first moment of time t=t₁, the pupil of the eye 127, shown with solid lines, is located at a first location 481. The controller 330 may be configured to compute the location x(t₁) of the high-efficiency portion 351 of the out-coupling grating 124 based on the first location determined by the eye tracking system 340. At a second moment of time t=t₂, the pupil of the eye 127, shown with dashed lines, is shifted to a second location 482. The controller 330 may be configured to compute the location x(t₂) of the high-efficiency portion 351 of the out-coupling grating 124 based on the second location determined by the eye tracking system 340. The controller 330 may then send corresponding commands (e.g. sets of voltages) to shift the location of the high-efficiency portion 351 of the out-coupling grating 124.

The adjustment of the movement function x(t) depending on the eye gaze direction is illustrated in FIG. 4B. At the first moment of time t=t₁, the eye 127, shown with solid lines, gazes in a first direction 491 shown by a solid arrow. The controller 330 may be configured to compute the location x(t₁) of the high-efficiency portion 351 of the out-coupling grating 124 based on the first gaze direction 491 determined by the eye tracking system 340. At the second moment of time t=t₂, the eye 127, shown with dashed lines, gazes in a second direction 492 denoted by a dashed arrow. The controller 330 may be configured to compute the location x(t₂) of the high-efficiency portion 351 of the out-coupling grating 124 based on the second gaze direction 492 determined by the eye tracking system 340. The controller 330 may then send corresponding commands (e.g. sets of voltages) to shift the location of the high-efficiency portion 351 of the out-coupling grating 124. A width of the high-efficiency portion 351 is determined by the FOV displayed at the corresponding moment of time. The width may be constant for constant FOV, or variable for variable FOV.

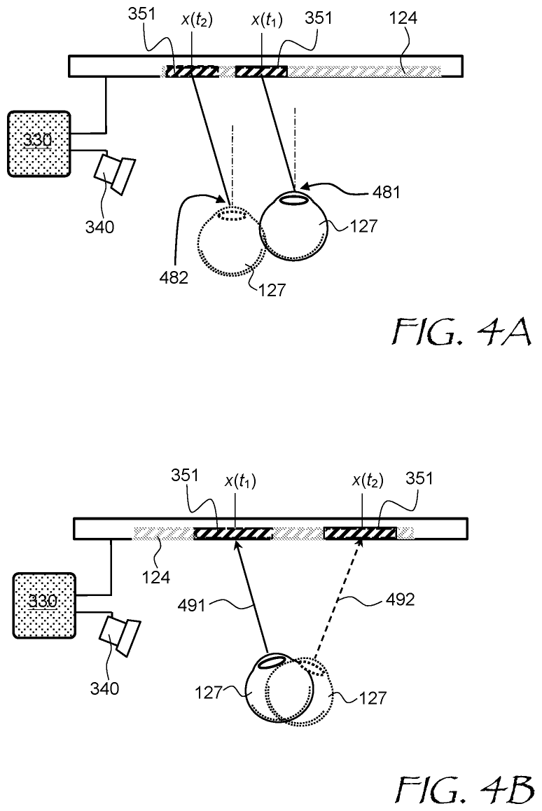

Referring to FIG. 5, a method 500 for providing an image, or more specifically for providing a line of an image in angular domain, includes angularly scanning (502) a light beam while modulating its brightness and/or color to provide the line of image in angular domain. This step may be performed e.g. by using the image projector 110 of the display device 100 of FIG. 1 or the display device 300 of FIG. 3. The scanned light beam is provided (504) to a pupil-replicating lightguide including an out-coupling grating having an out-coupling efficiency tunable in a spatially-selective manner, i.e. a grating having a tunable spatial profile of out-coupling efficiency. The out-coupling efficiency of the out-coupling grating is tuned (506) to provide a high-efficiency portion of the out-coupling grating running in coordination or in sync with the scanning of the light beam, as is explained above with reference to FIGS. 1 and 3, to keep a portion of the light beam at a first location at the eyebox during the scanning, e.g. at the location of the user's eye pupil. The first portion is out-coupled by the high-efficiency portion of the out-coupling grating.

The method 500 may further include using an eye tracking system to determine (508) a position of a pupil of a user's eye at the eyebox. The determined position is taken to be a position at which the out-coupled light beam portion is to be kept during the tuning (506). The determined position may be adjusted (510) upon determining, by the eye tracking system, that the pupil position and/or the gaze direction of the user's eye has shifted.

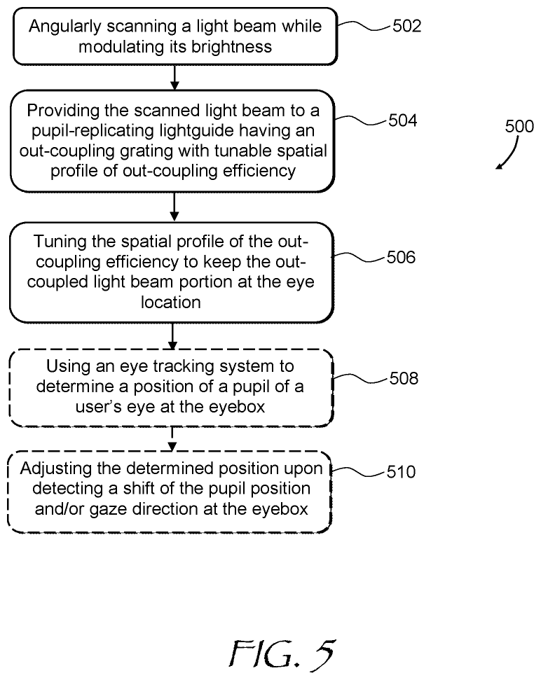

Non-limiting examples of spatially switchable/tunable gratings usable in lightguides and displays of this disclosure will now be presented. Referring first to FIG. 6, a tunable liquid crystal (LC) surface-relief grating 600 may be used as the out-coupling grating 124 of FIGS. 1 and 3. The tunable LC surface-relief grating 600 includes a first substrate 601 supporting a first conductive layer 611 and a surface-relief grating structure 604 having a plurality of ridges 606 extending from the first substrate 601 and/or the first conductive layer 611.

A second substrate 602 is spaced apart from the first substrate 601. The second substrate 602 supports a second conductive layer 612. A cell is formed by the first 611 and second 612 conductive layers. The cell is filled with an LC fluid, forming an LC layer 608. The LC layer 608 includes nematic LC molecules 610, which may be oriented by an electric field across the LC layer 608. The electric field may be provided by applying a voltage V to the first 611 and second 612 conductive layers or conductive electrodes. At least one of the first 611 and second 612 conductive layers may be pixelated to provide the spatially selective application of the voltage for spatial selectivity of the tuning.

The surface-relief grating structure 604 may be formed from a polymer with an isotropic refractive index nₚ of about 1.5, for example. The LC fluid has an anisotropic refractive index. For light polarization parallel to a director of the LC fluid, i.e. to the direction of orientation of the nematic LC molecules 610, the LC fluid has an extraordinary refractive index nₑ, which may be higher than an ordinary refractive index nₒ of the LC fluid for light polarization perpendicular to the director. For example, the extraordinary refractive index nₑ may be about 1.7, and the ordinary refractive index nₒ may be about 1.5, i.e. matched to the refractive index nₚ of the surface-relief grating structure 604.

When the voltage Vis not applied (left side of FIG. 6), the LC molecules 610 are aligned approximately parallel to the grooves of the surface-relief grating structure 604. At this configuration, a linearly polarized light beam 621 with e-vector oriented along the grooves of the surface-relief grating structure 604 will undergo diffraction, since the surface-relief grating structure 604 will have a non-zero refractive index contrast. When the voltage V is applied (right side of FIG. 6), the LC molecules 610 are aligned approximately perpendicular to the grooves of the surface-relief grating structure 604. At this configuration, a linearly polarized light beam 621 with e-vector oriented along the grooves of the surface-relief grating structure 604 will not undergo diffraction because the surface-relief grating structure 604 will appear to be index-matched and, accordingly, will have a substantially zero refractive index contrast. For the linearly polarized light beam 621 with e-vector oriented perpendicular to the grooves of the surface-relief grating structure 604, no diffraction will occur in either case (i.e. when the voltage is applied and when it is not) because at this polarization of the linearly polarized light beam 621, the surface-relief grating structure 604 are index-matched. Thus, the tunable LC surface-relief grating 600 can be switched on and off (for polarized light) by controlling the voltage across the LC layer 608. Several such gratings with differing pitch/slant angle/refractive index contrast may be used to switch between several grating configurations.

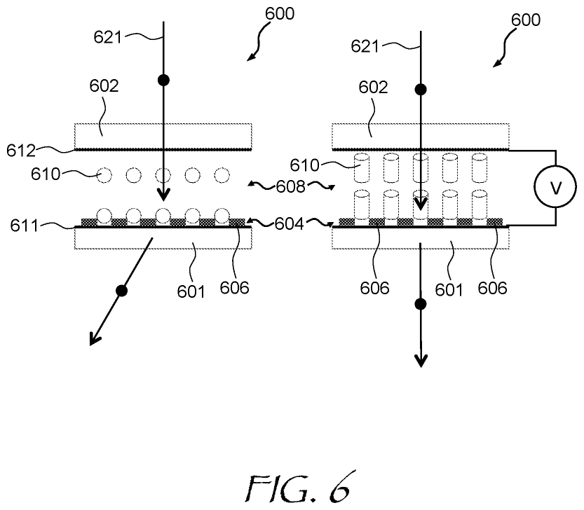

Referring now to FIG. 7A, a Pancharatnam-Berry phase (PBP) LC switchable grating 700 may be used as the out-coupling grating 124 of FIGS. 1 and 3. The PBP LC switchable grating 700 of FIG. 7A includes LC molecules 702 in an LC layer 704. The LC molecules 702 are disposed in XY plane at a varying in-plane orientation depending on the X coordinate. The orientation angle ϕ(x) of the LC molecules 702 in the PBP LC switchable grating 700 is given by

ϕ(x)=πx/T=πx sin θ/λₒ (1)

where λₒ is the wavelength of impinging light, T is a pitch of the PBP LC switchable grating 700, and θ is a diffraction angle given by

θ=sin⁻¹(λₒ/T) (2)

The azimuthal angle ϕ varies continuously across the surface of an LC layer 704 parallel to XY plane as illustrated in FIG. 7B. The variation has a constant period equal to T. The optical phase delay P in the PBP LC grating 700 of FIG. 7A is due to the PBP effect, which manifests P(x)=2ϕ(x) when the optical retardation R of the LC layer 704 is equal to λₒ/2.

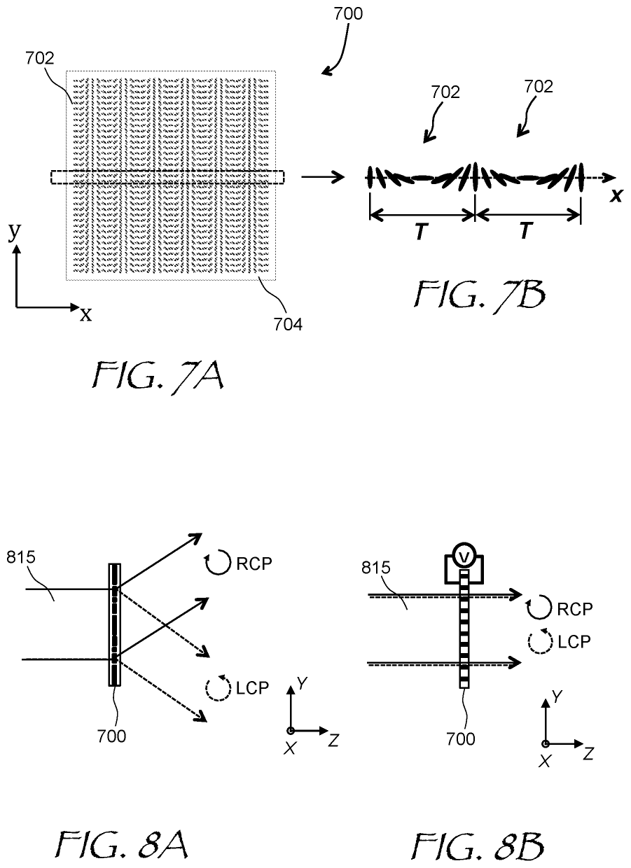

FIGS. 8A and 8B illustrate the operation of the PBP LC switchable grating 700 of FIG. 7A. The PBP LC switchable grating 700 includes the LC layer 704 (FIG. 7A) disposed between parallel substrates configured for applying an electric field across the LC layer 704. The LC molecules 702 are oriented substantially parallel to the substrates in absence of the electric field, and substantially perpendicular to the substrates in presence of the electric field.

In FIG. 8A, the PBP LC switchable grating 700 is in OFF state, such that its LC molecules 702 (FIGS. 7A, 7B) are disposed predominantly parallel to the substrate plane, that is, parallel to XY plane in FIG. 8A. When an incoming light beam 815 is left-circular polarized (LCP), the PBP LC switchable grating 700 redirects the light beam 815 upwards by a pre-determined non-zero angle, and the beam 815 becomes right-circular polarized (RCP). The RCP deflected beam 815 is shown with solid lines. When the incoming light beam 815 is right-circular polarized (RCP), the PBP LC switchable grating 700 redirects the beam 815 downwards by a pre-determined non-zero angle, and the beam 815 becomes left-circular polarized (LCP). The LCP deflected beam 815 is shown with dashed lines. Applying a voltage V to the PBP LC switchable grating 700 reorients the LC molecules along Z-axis, i.e. perpendicular to the substrate plane as shown in FIG. 8B. At this orientation of the LC molecules 702, the PBP structure is erased, and the light beam 815 retains its original direction, whether it is LCP or RCP. Thus, the active PBP LC grating 700 is a tunable grating, i.e. it has a variable beam steering property. Furthermore, the operation of the active PBP LC grating 700 may be controlled by controlling the polarization state of the impinging light beam 815.

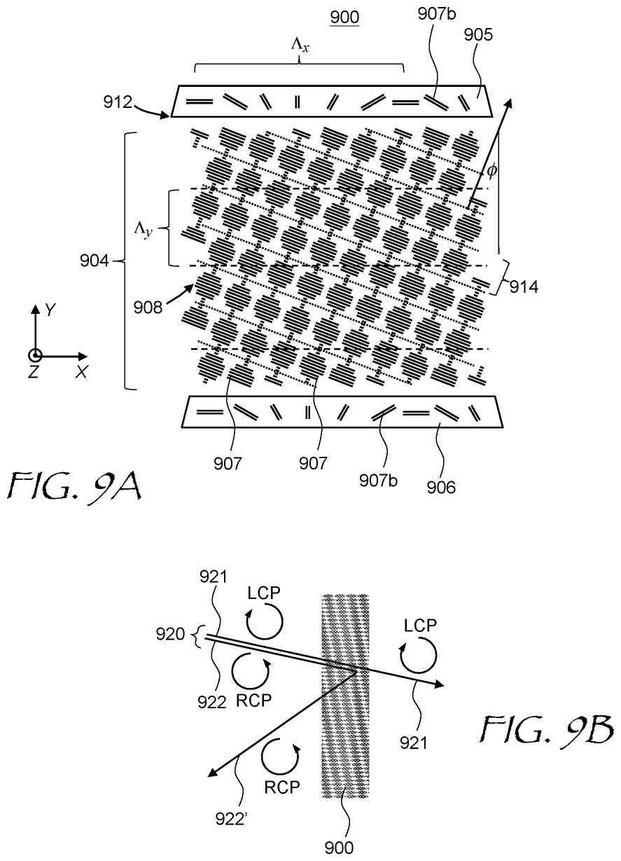

Turning to FIG. 9A, a polarization volume hologram (PVH) grating 900 may be used as the out-coupling grating 124 of FIGS. 1 and 3. The PVH grating 900 of FIG. 9A includes an LC layer 904 bound by opposed top 905 and bottom 906 parallel surfaces. The LC layer 904 may include an LC fluid containing rod-like LC molecules 907 with positive dielectric anisotropy, i.e. nematic LC molecules. A chiral dopant may be added to the LC fluid, causing the LC molecules in the LC fluid to self-organize into a periodic helical configuration including helical structures 908 extending between the top 905 and bottom 906 parallel surfaces of the LC layer 904. Such a configuration of the LC molecules 907, termed herein a cholesteric configuration, includes a plurality of helical periods p, e.g. at least two, at least five, at least ten, at least twenty, or at least fifty helical periods p between the top 905 and bottom 906 parallel surfaces of the LC layer 904.

Boundary LC molecules 907b at the top surface 905 of the LC layer 904 may be oriented at an angle to the top surface 905. The boundary LC molecules 907b may have a spatially varying azimuthal angle, e.g. linearly varying along X-axis parallel to the top surface 905, as shown in FIG. 9A. To that end, an alignment layer 912 may be provided at the top surface 905 of the LC layer 904. The alignment layer 912 may be configured to provide the desired orientation pattern of the boundary LC molecules 907b, such as the linear dependence of the azimuthal angle on the X-coordinate. A pattern of spatially varying polarization directions of the UV light may be selected to match a desired orientation pattern of the boundary LC molecules 907b at the top surface 905 and/or the bottom surface 906 of the LC layer 904. When the alignment layer 912 is coated with the cholesteric LC fluid, the boundary LC molecules 907b are oriented along the photopolymerized chains of the alignment layer 912, thus adopting the desired surface orientation pattern. Adjacent LC molecules adopt helical patterns extending from the top 905 to the bottom 906 surfaces of the LC layer 904, as shown.

The boundary LC molecules 907b define relative phases of the helical structures 908 having the helical period p. The helical structures 908 form a volume grating comprising helical fringes 914 tilted at an angle ϕ, as shown in FIG. 9A. The steepness of the tilt angle ϕ depends on the rate of variation of the azimuthal angle of the boundary LC molecules 907b at the top surface 905 and p. Thus, the tilt angle ϕ is determined by the surface alignment pattern of the boundary LC molecules 907b at the alignment layer 912. The volume grating has a period Δₓ along X-axis and Δ_{y} along Y-axis. In some embodiments, the periodic helical structures 908 of the LC molecules 907 may be polymer-stabilized by mixing in a stabilizing polymer into the LC fluid, and curing (polymerizing) the stabilizing polymer.

The helical nature of the fringes 914 of the volume grating makes the PVH grating 900 preferably responsive to light of polarization having one particular handedness, e.g. left- or right-circular polarization, while being substantially non-responsive to light of the opposite handedness of polarization. Thus, the helical fringes 914 make the PVH grating 900 polarization-selective, causing the PVH grating 900 to diffract light of only one handedness of circular polarization. This is illustrated in FIG. 9B, which shows a light beam 920 impinging onto the PVH grating 900. The light beam 920 includes a left circular polarized (LCP) beam component 921 and a right circular polarized (RCP) beam component 922. The LCP beam component 921 propagates through the PVH grating 900 substantially without diffraction. Herein, the term “substantially without diffraction” means that, even though an insignificant portion of the beam (the LCP beam component 921 in this case) might diffract, the portion of the diffracted light energy is so small that it does not impact the intended performance of the PVH grating 900. The RCP beam component 922 of the light beam 920 undergoes diffraction, producing a diffracted beam 922′. The polarization selectivity of the PVH grating 900 results from the effective refractive index of the grating being dependent on the relationship between the handedness, or chirality, of the impinging light beam and the handedness, or chirality, of the grating fringes 914. Changing the handedness of the impinging light may be used to switch the performance of the PVH grating 900. The PVH grating 900 may also be made tunable by applying voltage to the LC layer 904, which distorts or erases the above-described helical structure. It is further noted that sensitivity of the PVH 900 to right circular polarized light in particular is only meant as an illustrative example. When the handedness of the helical fringes 914 is reversed, the PVH 900 may be made sensitive to left circular polarized light. Thus, the operation of the PVH 900 may be controlled by controlling the polarization state of the impinging light beam 920. Furthermore, in some embodiments the PVH 900 may be made tunable by application of electric field across the LC layer 904, which erases the periodic helical structures 908.

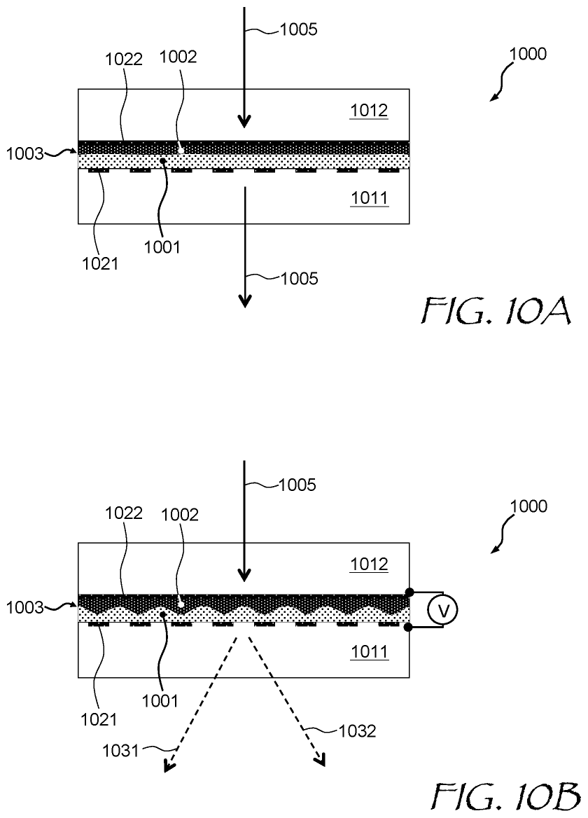

Referring now to FIGS. 10A and 10B, a fluidic surface-relief grating 1000 may be used as the out-coupling grating 124 of FIGS. 1 and 3. The fluidic surface-relief grating 1000 includes first 1001 and second 1002 immiscible fluids separated by an inter-fluid boundary 1003. One of the fluids may be a hydrophobic fluid such as oil, e.g. silicone oil, while the other fluid may be water-based. One of the first 1001 and second 1002 fluids may be a gas in some embodiments. The first 1001 and second 1002 fluids may be contained in a cell formed by first 1011 and second 1012 substrates supporting first 1021 and second 1022 electrode structures. The first 1021 and/or second 1022 electrode structures may be at least partially transparent, absorptive, and/or reflective.

At least one of the first 1021 and second 1022 electrode structures may be pixelated/segmented/patterned for imposing a spatially variant electric field onto the 1001 and second 1002 fluids. For example, in 10A and 10B, the first electrode 1021 is patterned, and the second electrodes 1022 is not patterned, i.e. the second electrodes 1022 is a backplane electrode. In the embodiment shown, both the first 1021 and second 1022 electrodes are substantially transparent. For example, the first 1021 and second 1022 electrodes may be indium tin oxide (ITO) electrodes. The individual portions of a patterned electrode may be individually addressable. In some embodiments, the patterned electrode 1021 may be replaced with a continuous, non-patterned electrode coupled to a patterned dielectric layer for creating a spatially non-uniform electric field across the first 1001 and second 1002 fluids.

FIG. 10A shows the fluidic surface-relief grating 1000 in a non-driven state when no electric field is applied across the inter-fluid boundary 1003. When no electric field is present, the inter-fluid boundary 1003 is straight and smooth; accordingly, a light beam 1005 impinging onto the fluidic surface-relief grating 1000 does not diffract, propagating right through as illustrated. FIG. 10B shows the fluidic surface-relief grating 1000 in a driven state when a voltage V is applied between the first 1021 and second 1022 electrodes, producing a spatially variant electric field across the first 1001 and second 1002 fluids separated by the inter-fluid boundary 1003. The application of the spatially variant electric field causes the inter-fluid boundary 1003 to distort as illustrated in FIG. 10B, forming a periodic variation of effective refractive index, i.e. a surface-relief diffraction grating. The light beam 1005 impinging onto the fluidic surface-relief grating 1000 will diffract, forming first 1031 and second 1032 diffracted sub-beams. By varying the amplitude of the applied voltage V, the strength of the fluidic surface-relief grating 1000 may be varied. By applying different patterns of the electric field e.g. with individually addressable sub-electrodes or pixels of the first electrode 1021, the grating period and, accordingly, the diffraction angle, may be varied. More generally, varying the effective voltage between separate sub-electrodes or pixels of the first electrode 1021 may result in a three-dimensional conformal change of the fluidic interface i.e. the inter-fluid boundary 1003 inside the fluidic volume to impart a desired optical response to the fluidic surface-relief grating 1000. The applied voltage pattern may be pre-biased to compensate or offset gravity effects, i.e. gravity-caused distortions of the inter-fluid boundary 1003.

The thickness of the first 1021 and second 1022 electrodes may be e.g. between 10 nm and 50 nm. The materials of the first 1021 and second 1022 electrodes besides ITO may be e.g. indium zinc oxide (IZO), zinc oxide (ZO), indium oxide (TO), tin oxide (TO), indium gallium zinc oxide (IGZO), etc. The first 1001 and second 1002 fluids may have a refractive index difference of at least 0.1, and may be as high as 0.2 and higher. One of the first 1001 or second 1002 fluids may include polyphenylether, 1,3-bis(phenylthio)benzene, etc. The first 1011 and/or second 1012 substrates may include e.g. fused silica, quartz, sapphire, etc. The first 1011 and/or second 1012 substrates may be straight or curved, and may include vias and other electrical interconnects. The applied voltage may be varied in amplitude and/or duty cycle when applied at a frequency of between 100 Hz and 100 kHz. The applied voltage can change polarity and/or be bipolar. Individual first 1001 and/r second 1002 fluid layers may have a thickness of between 0.5-5 micrometers, more preferably between 0.5-2 micrometer.

To separate the first 1001 and second 1002 fluids, surfactants containing one hydrophilic end functional group and one hydrophobic end functional group may be used. The examples of a hydrophilic end functional group are hydroxyl, carboxyl, carbonyl, amino, phosphate, sulfhydryl. The hydrophilic functional groups may also be anionic groups such as sulfate, sulfonate, carboxylates, phosphates, for example. Non-limiting examples of a hydrophobic end functional group are aliphatic groups, aromatic groups, fluorinated groups. For example, when polyphenyl thioether and fluorinated fluid may be selected as a fluid pair, a surfactant containing aromatic end group and fluronirated end group may be used. When phenyl silicone oil and water are selected as the fluid pair, a surfactant containing aromatic end group and hydroxyl (or amino, or ionic) end group may be used. These are only non-limiting examples.

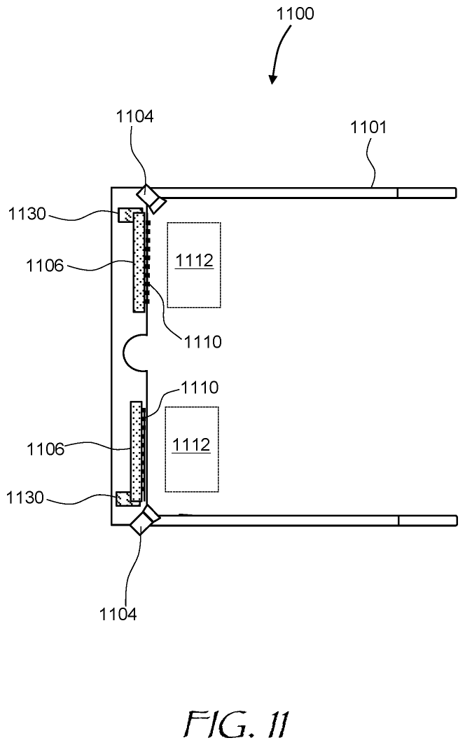

Referring now to FIG. 11, an augmented reality (AR) near-eye display 1100 is an embodiment of the display device 100 of FIG. 1 and/or the display device 300 of FIG. 3. The AR near-eye display 1100 of FIG. 11 includes a frame 1101 supporting, for each eye: a light engine or image projector 1130 for providing an image light beam carrying an image in angular domain, a pupil-replicating lightguide 1106 including any of the waveguides disclosed herein, for providing multiple offset portions of the image light beam to spread the image in angular domain across an eyebox 1112, and a plurality of eyebox illuminators 1110, shown as black dots, spread around a clear aperture of the pupil-replicating lightguide 1106 on a surface that faces the eyebox 1112. An eye-tracking camera 1104 may be provided for each eyebox 1112.

The purpose of the eye-tracking cameras 1104 is to determine position and/or orientation of both eyes of the user. The eyebox illuminators 1110 illuminate the eyes at the corresponding eyeboxes 1112, allowing the eye-tracking cameras 1104 to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with the light of the eyebox illuminators 1110, the latter may be made to emit light invisible to the user. For example, infrared light may be used to illuminate the eyeboxes 1112.

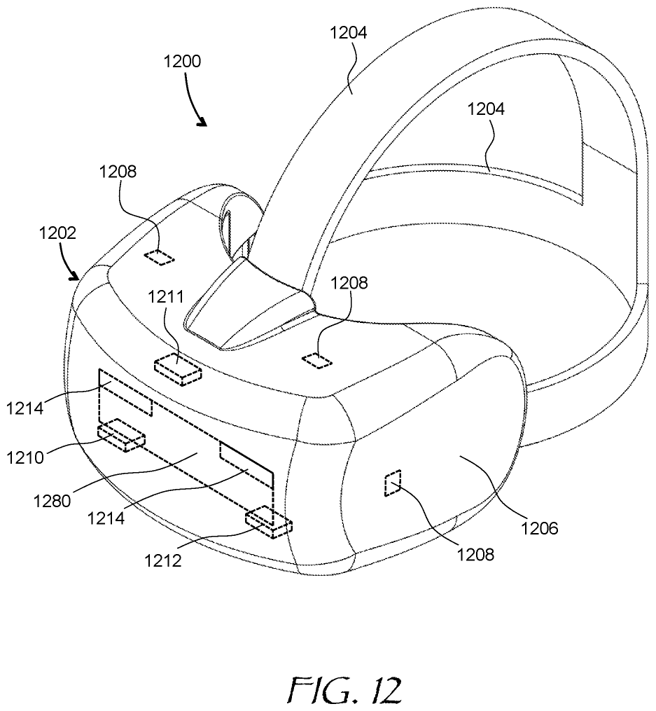

Turning to FIG. 12, an HMD 1200 is an example of an AR/VR wearable display system which encloses the user's face, for a greater degree of immersion into the AR/VR environment. The HMD 1200 may generate the entirely virtual 3D imagery. The HMD 1200 may include a front body 1202 and a band 1204 that can be secured around the user's head. The front body 1202 is configured for placement in front of eyes of a user in a reliable and comfortable manner. A display system 1280 may be disposed in the front body 1202 for presenting AR/VR imagery to the user. The display system 1280 may include any of the display devices and waveguides disclosed herein. Sides 1206 of the front body 1202 may be opaque or transparent.

In some embodiments, the front body 1202 includes locators 1208 and an inertial measurement unit (IMU) 1210 for tracking acceleration of the HMD 1200, and position sensors 1212 for tracking position of the HMD 1200. The IMU 1210 is an electronic device that generates data indicating a position of the HMD 1200 based on measurement signals received from one or more of position sensors 1212, which generate one or more measurement signals in response to motion of the HMD 1200. Examples of position sensors 1212 include: one or more accelerometers, one or more gyroscopes, one or more magnetometers, another suitable type of sensor that detects motion, a type of sensor used for error correction of the IMU 1210, or some combination thereof. The position sensors 1212 may be located external to the IMU 1210, internal to the IMU 1210, or some combination thereof.

The locators 1208 are traced by an external imaging device of a virtual reality system, such that the virtual reality system can track the location and orientation of the entire HMD 1200. Information generated by the IMU 1210 and the position sensors 1212 may be compared with the position and orientation obtained by tracking the locators 1208, for improved tracking accuracy of position and orientation of the HMD 1200. Accurate position and orientation is important for presenting appropriate virtual scenery to the user as the latter moves and turns in 3D space.

The HMD 1200 may further include a depth camera assembly (DCA) 1211, which captures data describing depth information of a local area surrounding some or all of the HMD 1200. The depth information may be compared with the information from the IMU 1210, for better accuracy of determination of position and orientation of the HMD 1200 in 3D space.

The HMD 1200 may further include an eye tracking system 1214 for determining orientation and position of user's eyes in real time. The obtained position and orientation of the eyes also allows the HMD 1200 to determine the gaze direction of the user and to adjust the image generated by the display system 1280 accordingly. The determined gaze direction and vergence angle may be used to adjust the display system 1280 to reduce the vergence-accommodation conflict. The direction and vergence may also be used for displays' exit pupil steering as disclosed herein. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1202.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A display device comprising:
an image projector for providing image light carrying an image in angular domain; and
a pupil-replicating lightguide coupled to the image projector and comprising an out-coupling grating for out-coupling spaced apart portions of the image light towards an eyebox;
wherein an out-coupling efficiency of the out-coupling grating is tunable in a spatially-selective manner for providing a configurable distribution of the image light portions at the eyebox.

2. The display device of claim 1, further comprising a controller operably coupled to the image projector and the out-coupling grating and configured to:
cause the image projector to provide a first field of view (FOV) portion;
increase the out-coupling efficiency of a first portion of the out-coupling grating to increase a first portion of the image light corresponding to the first FOV portion;
cause the image projector to provide a second, different FOV portion; and
increase the out-coupling efficiency of a second portion of the out-coupling grating to increase a second portion of the image light corresponding to the second FOV portion.

3. The display device of claim 2, wherein the first FOV portion comprises a first line of the image in angular domain, and the second FOV portion comprises a second, different line of the image in angular domain.

4. The display device of claim 2, wherein the first FOV portion comprises a first section of the image in angular domain, and the second FOV portion comprises a second, different section of the image in angular domain.

5. The display device of claim 1, further comprising:
an eye tracking system for determining a position of a pupil of a user's eye at the eyebox; and
a controller operably coupled to the image projector, the out-coupling grating, and the eye tracking system, and configured to:
cause the eye tracking system to determine the position of the pupil of the user's eye;
cause the image projector to provide a first field of view (FOV) portion; and
increase the out-coupling efficiency of a first portion of the out-coupling grating to increase a first portion of the image light at the position of the pupil determined by the eye tracking system, the first image light portion corresponding to the first FOV portion.

6. The display device of claim 1, wherein the out-coupling grating comprises a polarization volume hologram (PVH) grating.

7. The display device of claim 1, wherein the out-coupling grating comprises a tunable Pancharatnam-Berry phase (PBP) liquid crystal (LC) grating.

8. The display device of claim 1, wherein the out-coupling grating comprises a fluidic surface-relief grating.

9. The display device of claim 1, wherein the image projector comprises a scanning image projector.

10. A display device comprising:
a scanning image projector for scanning a light beam to provide a line of an image in angular domain; and
a pupil-replicating lightguide coupled to the image projector and comprising an out-coupling grating for out-coupling spaced apart portions of the light beam towards an eyebox;
wherein an out-coupling efficiency of the out-coupling grating is tunable in a spatially-selective manner.

11. The display device of claim 10, further comprising a controller operably coupled to the scanning image projector and the out-coupling grating and configured to:
cause the scanning image projector to scan the light beam from a first pixel to a second pixel of the line of the image; and
tune the out-coupling efficiency of the out-coupling grating to provide a high-efficiency portion of the out-coupling grating running in coordination with scanning of the light beam by the scanning image projector, to keep a first portion of the light beam at a first location at the eyebox during the scanning, wherein the first portion is out-coupled by the high-efficiency portion of the out-coupling grating.

12. The display device of claim 11, wherein an x-coordinate x(t) of the high-efficiency portion is expressed as x(t)=D*tan(θ(t)), wherein D is a distance between the out-coupling grating and the first location, θ(t) is an instantaneous scanning angle of the light beam, and t is time.

13. The display device of claim 11, further comprising an eye tracking system operably coupled to the controller for determining a position of a pupil of a user's eye at the eyebox, wherein the first location is at the pupil position determined by the eye tracking system.

14. The display device of claim 13, wherein the controller is further configured to adjust the first location upon determining, using the eye tracking system, that the pupil position has shifted.

15. The display device of claim 13, wherein the controller is further configured to adjust the first location upon determining, using the eye tracking system, that a gaze direction of the user's eye has shifted.

16. A method for providing a line of an image in angular domain to a first location at an eyebox, the method comprising:
angularly scanning a light beam while modulating its brightness to provide the line of the image in angular domain;
providing the scanned light beam to a pupil-replicating lightguide comprising an out-coupling grating having an out-coupling efficiency tunable in a spatially-selective manner; and
tuning the out-coupling efficiency of the out-coupling grating to provide a high-efficiency portion of the out-coupling grating running in coordination with the scanning of the light beam, to keep a first portion of the light beam at a first location at the eyebox during the scanning, wherein the first portion is out-coupled by the high-efficiency portion of the out-coupling grating.

17. The method of claim 16, wherein an x-coordinate x(t) of the high-efficiency portion is expressed as x(t)=D*tan(θ(t)), wherein D is a distance between the out-coupling grating and the first location, θ(t) is an instantaneous scanning angle of the light beam, and t is time.

18. The method of claim 16, further comprising using an eye tracking system to determine a position of a pupil of a user's eye at the eyebox, wherein the first location is at the pupil position determined by the eye tracking system.

19. The method of claim 18, further comprising adjusting the first location upon determining, using the eye tracking system, that the pupil position has shifted.

20. The method of claim 18, further comprising adjusting the first location upon determining, using the eye tracking system, that a gaze direction of the user's eye has shifted.
